(19) United States
(12) Patent Application Publication
(10) Pub. No.: US 2018/0283610 A1
(43) Pub. Date: Oct. 4, 2018

(54) TANK ENCLOSURE AND TANK MOUNT SYSTEM AND METHOD

(71) Applicant: Other Lab, LLC, San Francisco, CA (US)

(72) Inventors: Jason Stein Wexler, San Francisco, CA (US); Kevin Kai Morris, Tiburon, CA (US); Brian Matthew Schlotterbeck, San Francisco, CA (US); Durward Kimball Stone, Oakland, CA (US); Karthick Chandraseker, San Francisco, CA (US)

(21) Appl. No.: 15/940,793

(22) Filed: Mar. 29, 2018

Related U.S. Application Data
(60) Provisional application No. 62/479,598, filed on Mar. 31, 2017.

(51) Int. Cl. F17C 1/06; B60K 15/03

(52) U.S. Cl. CPC F17C 1/06; F17C 1/16; B60K 15/03006

(57) ABSTRACT

One aspect includes a folded tank assembly having an elongated tank that extends between a first and second end. The elongated tank has a plurality of elongated rigid tubing portions having a first diameter, a plurality of connector portions having a second diameter that is smaller than the first diameter, and taper portions disposed between and coupling successive tubing portions and connector portions. The elongated tank is folded to define a folded tank body having a first and second tank body end, with the elongated rigid tubing portions extending between the first and second tank body ends and with the plurality of connector portions being disposed at one of the first or second tank body ends. A first tank mount is disposed at the first tank body end and a second tank mount disposed at the second tank body end.

### CROSS-REFERENCE TO RELATED APPLICATIONS

This application is a non-provisional of and claims priority to U.S. Provisional application entitled “TANK ENCLOSURE AND TANK MOUNT SYSTEM AND METHOD” and having application No. 62/479,598 filed Mar. 31, 2017. This application is hereby incorporated herein by reference in its entirety and for all purposes.

This application is related to U.S. application Ser. No. 13/887,201 filed May 3, 2013; U.S. application Ser. No. 14/172,831 filed Feb. 4, 2014; U.S. application Ser. No. 15/183,614 filed Jun. 15, 2016; U.S. application Ser. No. 14/624,370 filed Feb. 17, 2015; U.S. application Ser. No. 15/368,182 filed Dec. 2, 2016; U.S. application Ser. No. 15/792,090 filed Oct. 24, 2017; U.S. Application Ser. No. 62/479,598 filed Mar. 31, 2017; and U.S. Application Ser. No. 62/479,699 filed Mar. 31, 2017. These applications are hereby incorporated herein by reference in their entirety and for all purposes.

### BRIEF DESCRIPTION OF THE DRAWINGS

FIGS. 1a and 1b illustrate side views of a bare liner comprising a body having connector portions, taper portions and tubing portions.

FIG. 1c illustrates a close-up side view of corrugations of connector portions of a bare liner.

FIG. 1d illustrates a close-up side view of corrugations of tubing portions of a bare liner.

FIG. 2a illustrates a side view of a bare liner bending via corrugations of the connector portions.

FIG. 2b illustrates a side view of the liner of FIG. 2a covered with braiding.

FIG. 3 illustrates a side view of a bare liner comprising a body having a connector portion with a cuff and corrugations, a taper portion and tubing portion.

FIG. 4 illustrates a tank folded to define a folded tank body having a first and second folded tank body end with tubing portions extending between the ends.

FIG. 5 illustrates one example embodiment of an enclosure assembly including a folded tank body.

FIG. 6a illustrates a method of assembling an enclosure assembly, including coupling interface brackets at first and second tank body ends of a tank body.

FIG. 6b illustrates coupling a tank body having tank mounts and interface brackets into an enclosure.

FIGS. 7a and 7b illustrate coupling a cover with an enclosure having a tank body disposed therein.

FIG. 8a illustrates a tank mount of one embodiment coupled at one tank body end of a folded tank body.

FIG. 8b illustrates a tank mount of another embodiment coupled at one tank body end of a folded tank body.

FIG. 9 illustrates a tank mount of a further embodiment coupled at one tank body end of a folded tank body.

FIG. 10 illustrates an example embodiment of a folded tank body having a single layer of six tubing portions extending between a first and second folded tank body end with tank mounts coupled at the first and second tank body ends.

FIG. 11a illustrates an embodiment of a tank mount defining two tank mount coupling holes.

FIG. 11b illustrates another embodiment of a tank mount defining three tank mount coupling holes.

FIG. 11c illustrates a further embodiment of a tank mount defining six tank mount coupling holes.

FIG. 12 illustrates an embodiment of a folded tank body having two layers of three tubing portions extending between a first and second folded tank body end with tank mounts at the first and second tank body ends in exploded view.

FIG. 13 illustrates an embodiment of a folded tank body having two layers of three tubing portions extending between a first and second folded tank body end with tank mounts at the first and second tank body ends.

FIG. 14 illustrates an embodiment of a tank mount defining six tank mount coupling holes disposed in two rows of three tank mount coupling holes.

FIG. 15 illustrates an example of a folded tank body having four layers which includes nine tubing portions in the first and third layers and ten tubing portions in the second and fourth layers.

FIG. 16 illustrates a further example of a folded tank body having two layers that include twenty tubing portions in the first layer and twenty one tubing portions in the second layer.

FIG. 17 illustrates an example of a vehicle of one embodiment that includes a tank enclosure assembly coupled to the chassis of the vehicle.

FIG. 18 illustrates one example embodiment where a first tank body and second tank body are disposed within a tank enclosure assembly.

FIG. 19 illustrates an example embodiment of a plurality of folded tank bodies coupled with a vehicle where the tank bodies have irregular shapes and/or non-cuboid shapes.

FIG. 20 illustrates an enclosure assembly comprising a thermally-activated pressure relief device (TPRD) assembly that includes a TPRD coupled to a first coupler of a folded tank body with a trigger line extending from the TPRD.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

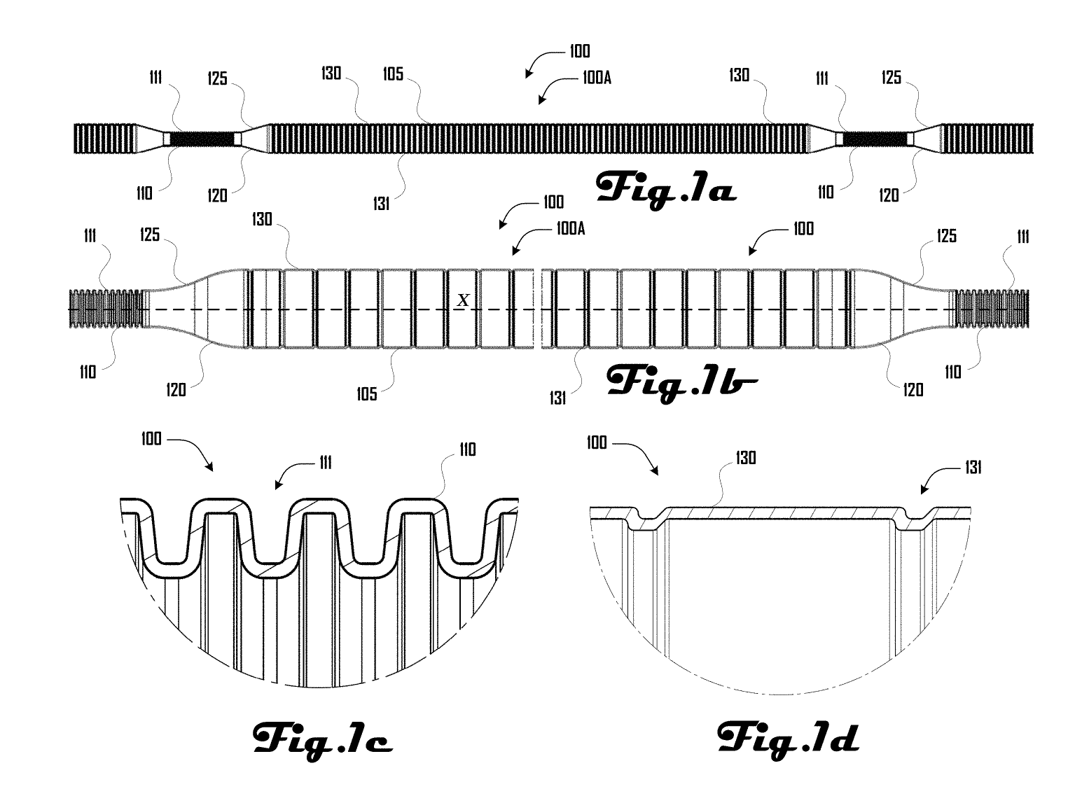

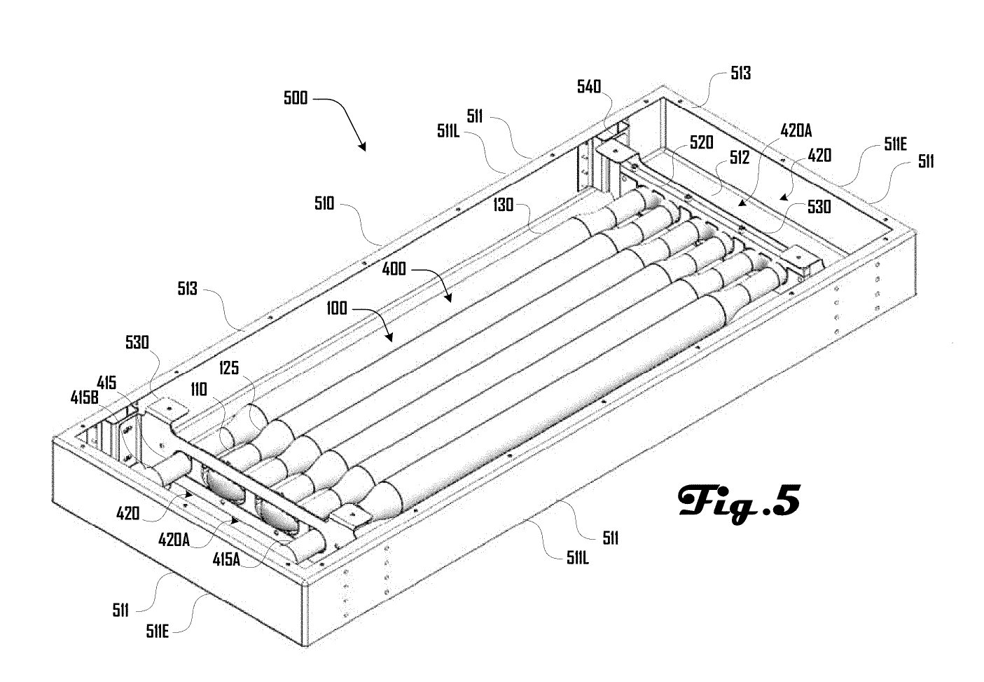

Turning to FIGS. 1a-d, a bare liner 100A is shown as comprising a body 105 having connector portions 110, taper portions 125, and tubing portions 130. The connector portion 110 can be corrugated, which can allow the connector portion 110 to be flexible such that the liner 100 can be folded into an enclosure 500 as illustrated in FIG. 5. Non-corrugated portions 120 can be rigid in various embodiments.

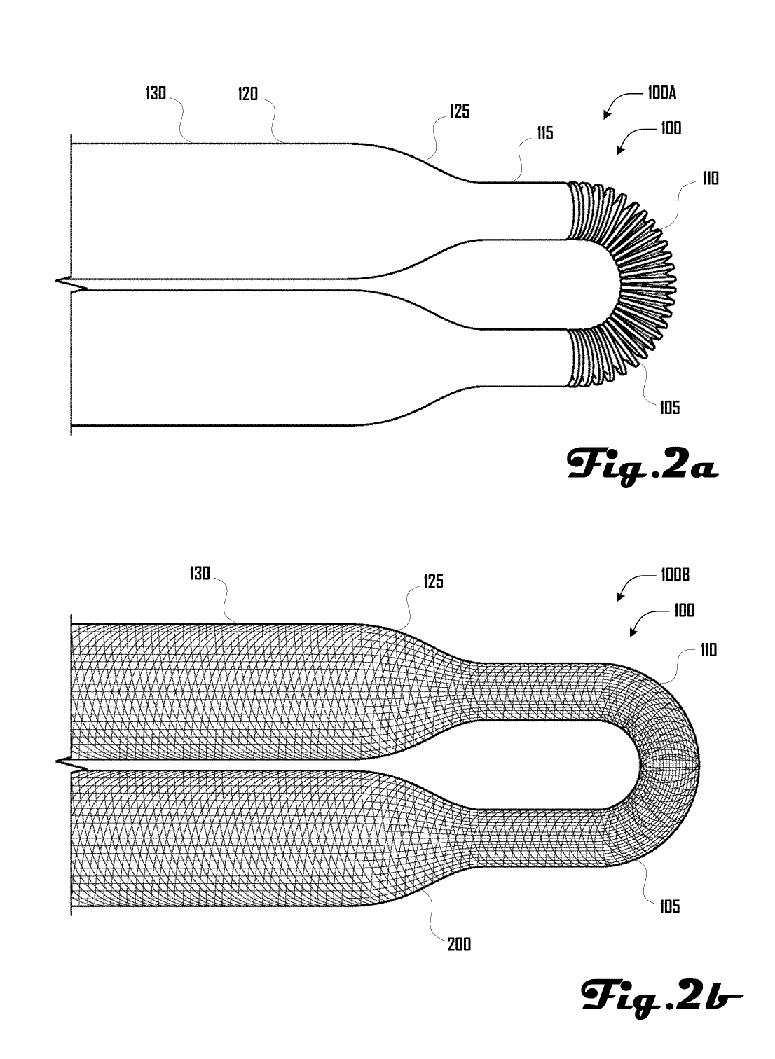

In various embodiments, the connector portion 110 can have a diameter that is smaller than the tubing portions 130, with the taper portion 125 providing a transition between the diameter of the connector portion 110 and the tubing portion 130. However, further embodiments can comprise a liner 100 with portions having one or more suitable diameters, and in further embodiments, a liner 100 can have portions that are non-cylindrical, which can include various suitable shapes. The connector portion 110 can comprise connector corrugations 111, which can allow the connector portion 110 to be flexible (e.g., as illustrated in FIGS. 2a and 2b) such that the liner 100 can be folded into an enclosure 500 as illustrated in FIG. 5.

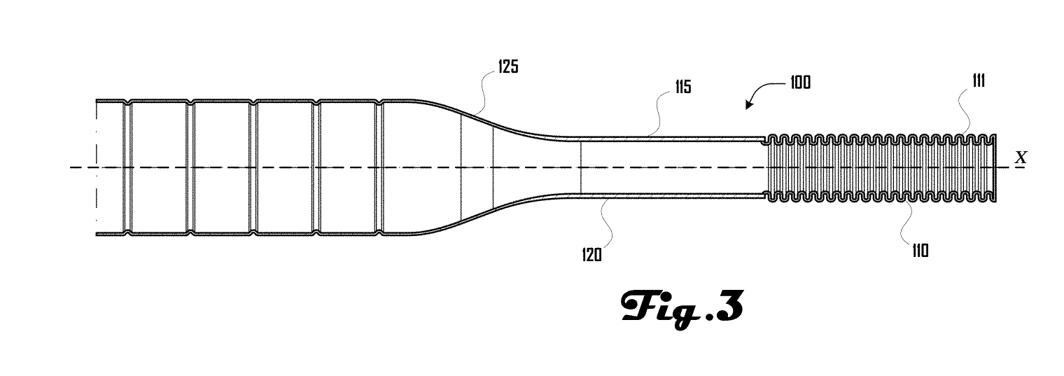

Additionally, as illustrated in FIGS. 1a, 1b, 2a and 3 the connector portion 110 can comprise a cuff portion 115 defined by a non-corrugated portion 120 or the rigid portion of the connector portion 110 between the corrugations 111 of the connector portion 110 and the taper portion 125. In further embodiments, the cuff portion 115 can be various sizes as illustrated in FIGS. 1a, 1b, 2a and 3. More specifically, FIGS. 1a and 1b illustrate a cuff portion 115 being smaller compared to the cuff portion 115 as illustrated in FIGS. 2a and 3. In some embodiments, the cuff portion 115 can have a length that is less than, equal to, or greater than the length of the taper portion 125. In some embodiments, the taper portion 125 can have a length that is less than, equal to, or greater than the length of the cuff portion 115 or twice the length of the cuff portion 115.

Similarly, in some embodiments, the tubing portions 130 can comprise corrugations 131. However, in further embodiments, the corrugations 131 can be absent from the tubing portions (e.g., as illustrated in FIG. 2a). Non-corrugated portions 120 can be rigid in various embodiments.

In one embodiment, the liner 100 can be generated via extrusion molding systems, or the like, which can comprise rotating dies that are configured to rotate in concert such that corresponding dies mate about an extruded tube generated by an extruder. Corresponding mated dies can thereby define one or more of the connector portion 110, taper portion 125 and/or the tubing portion 130.

In various embodiments, a vacuum can pull the material of an extruded tube to conform to negative contours defined by the mated die. In some embodiments, positive pressure can be introduced within the tube to conform to negative contours defined by the mated die. In various embodiments, such a manufacturing process can be beneficial because liners 100 can be made seamlessly, with no welds, and using a single material.

In some embodiments, liners 100 having varying lengths of the connector portion 110, taper portion 125 and/or the tubing portion 130, can be made by selectively choosing the order of dies such that desired portions are made longer or shorter. For example, in some embodiments, a liner 100 can be produced that fits into an irregular or non-rectangular cavity, which can require a liner 100 to have tubing portions 130 of variable lengths.

In some embodiments, a liner 100 can be made by forming various pieces of the liner 100 and then coupling the pieces together. For example, connector portion 110 can be manufactured separately from the taper portion 125 and/or the tubing portion 130, and/or the cuff portion 115. Such separate portions can be subsequently coupled together to form the liner 100.

A liner 100 can comprise various suitable materials including plastic, metal, or the like. In some preferred embodiments, a liner 100 can comprise Ultramid PA6, Rilsamid PA12, Lupolen HDPE, or the like.

Accordingly, the embodiments of a liner 100 shown and described herein should not be construed to be limiting on the wide variety of liners 100 that are within the scope and spirit of the present invention. For example, liners 100 as described U.S. Provisional Patent Application No. 62/175,914, which is incorporated herein by reference, illustrate some further example embodiments of liners 100.

In some embodiments, a liner 100 can be a naked liner 100A as illustrated in FIGS. 1a-d, and 2a. However, as illustrated in FIG. 2b, in some embodiments a liner 100 can be a covered or over-braided liner 100B, which can include a braiding 200, or other suitable covering. An over-braided liner 110B can be desirable because the braiding 200 can increase the strength of the liner and thereby increase the duty pressure under which the liner 100 may safely operate. Additionally, braiding 200 can be disposed in a plurality of layers in various embodiments. For example, in one preferred embodiment, the braid 200 can comprise seven layers of 48 carrier carbon braid 200.

As discussed in detail herein, the material(s), shape, size, configuration and other variables related to a braid 200 can be chosen to increase the strength provided by the braiding 200, increase the flexibility of the braiding 200, increase the strength to weight ratio of the braiding and the like. In various preferred embodiments, braiding 200 can be configured to completely cover a liner 100. In other words, one or more layers of braiding 200 can be configured to cover the liner 100 such that the liner is not visible through the braid 200 once applied to the liner 100 and such that gaps between the braid are not present such that the liner 100 is visible through the braid 200.

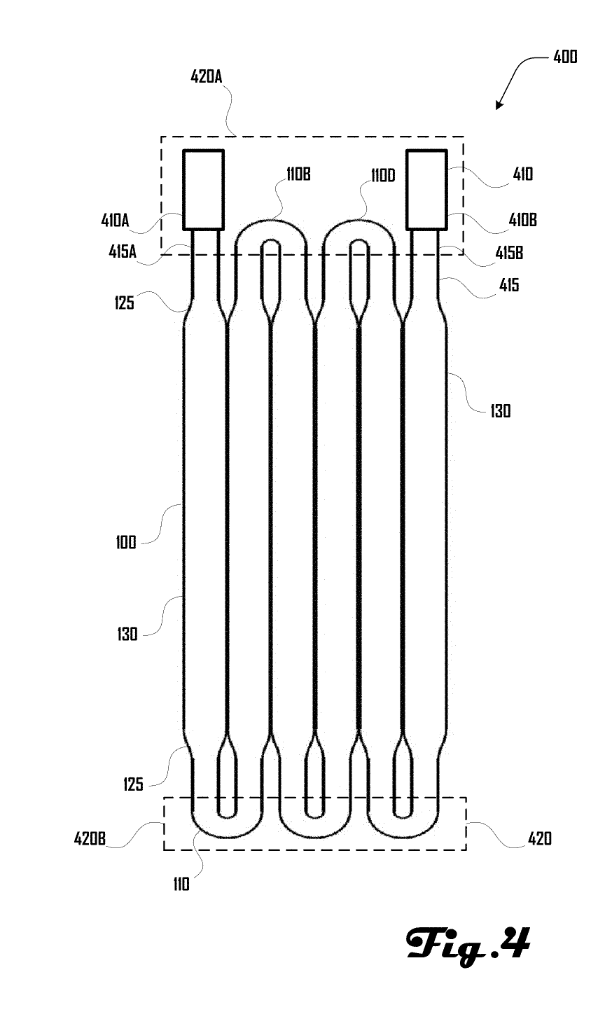

Turning to FIG. 4, a tank 100 in a folded configuration that defines a folded tank body 400 is illustrated, which includes a plurality of tubing portions 130 aligned in parallel and extending between a first and second tank body end 420A, 420B of the folded tank body 400. In this example, the tank 100 that defines the folded tank body 400 includes a first tank end 415A disposed at the first tank body end 420A. The tank 100 extends from the first tank end 415A at the first tank body end 420A to a first connector portion 110A at the second tank body end 420B; then to a second connector portion 110B at the first tank body end 420A; then to a third connector portion 110C at the second tank body end 420B; then to a fourth connector portion 110D at the first tank body end 420A; then to a fifth connector portion 110E at the second tank body end 420B; then to a second tank end 415B at the first tank body end 420B.

Fittings 410 can be coupled at the ends 415 of the tank 100. More specifically, a first a first fitting 410A can be coupled at the first end 415A of the tank 100, and a second fitting 410B can be coupled at the second end 415B of the tank 100. Examples of fittings in accordance with some embodiments are shown and described in U.S. patent application Ser. No. 15/792,090 entitled FITTINGS FOR COMPRESSED GAS STORAGE VESSELS, filed Oct. 24, 2017, which as discussed above is incorporated herein by reference in its entirety for all purposes. Although FIG. 4 illustrates fittings 410 coupled to the connector portion 110 of the tank 100, in further embodiments, fittings can be coupled at any suitable portion of the tank 100, including the cuff portions 115, taper portions 125 and/or tubing portions 130. Such fittings 410 can include crimp fittings, bolt fittings, or any other suitable type of fitting.

FIG. 4 illustrates a folded tank body 400 defined by six tubing portions 130 disposed in parallel and in a common plane to define a single layer of tubing portions 130 extending between ends 420 of the folded tank body 400. In this example, the first end 420A comprises two connector portions 110 and the ends 415 of the tank 100. The second end comprises three connector portions 110.

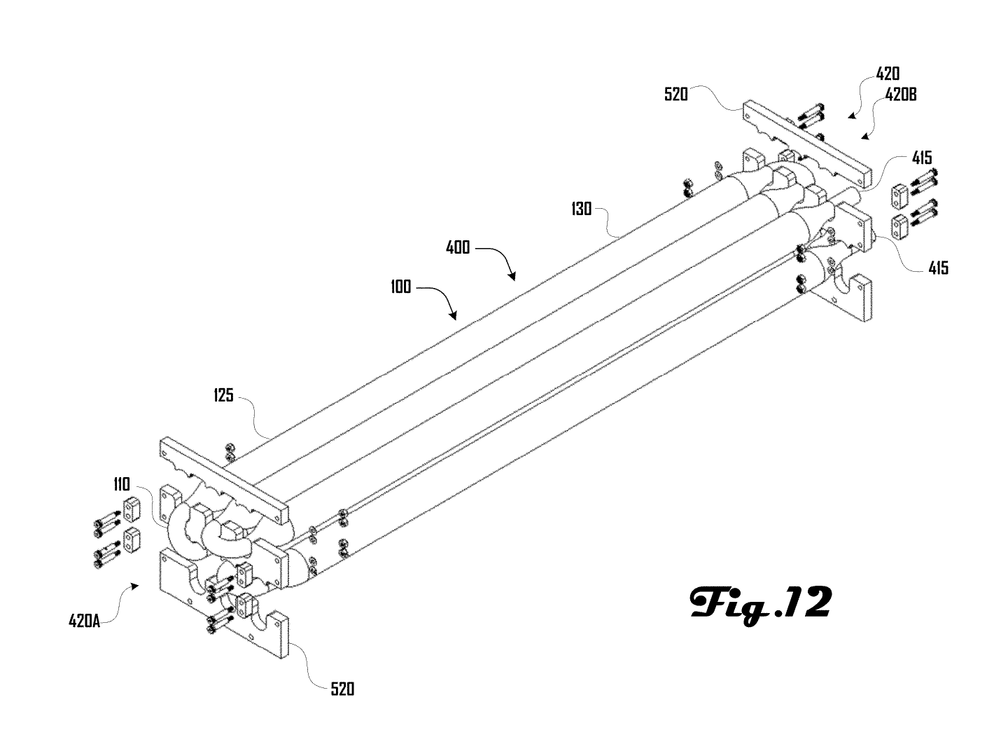

However, it should be clear that the example tank 100 and tank body 400 of FIG. 4 is only one example of the many embodiments of tanks 100 and tank bodies 400 that are within the scope and spirit of the present disclosure. For example, in further embodiments, any suitable plurality tubing portions 130 can extend between ends 420 of a folded tank body 400. Additionally, in further embodiments as described in more details herein, a folded tank body 400 can define a plurality of layers of tubing portions 130 (see e.g., FIGS. 12, 13, 15 and 17).

Additionally, while FIG. 4 illustrates both ends 415 of the tank 100 being disposed on the same end 420 of the folded tank body 400, in further embodiments the ends 415 of the tank 100 can be disposed on opposite ends of the folded tank body 400. Additionally, in embodiments having a plurality of layer of tubing portions 130 that extend between ends 420 of a folded tank body 400, the ends 415 of the tank 100 being disposed at different layers as described in more detail herein.

Turning to FIG. 5, a tank enclosure assembly 500 in accordance with one embodiment is illustrated. The enclosure assembly 500 comprise a folded tank body 400 disposed within an enclosure 510, with tank mounts 520 disposed at the ends 420 of the folded tank body 400. Interface brackets 530 that are coupled to the enclosure 510 via a fastening bracket 540 can engage the tank mounts 520 at the ends 420 of the folded tank body 400 to secure the folded tank body 400 within the enclosure 510.

FIG. 5 illustrates a folded tank body 400 defined by six tubing portions 130 disposed in parallel and in a common plane to define a single layer of tubing portions 130 extending between ends 420 of the folded tank body 400. In this example, the first end 420A comprises two connector portions 110 and the ends 415 of the tank 100 and the second end 420B comprises three connector portions 110. However, it should be clear that the example enclosure 510, tank mounts 520, interface bracket 530, and the like can be configured for a folded tank body 400 having any suitable configuration as described herein, including one or more layers of tubing portions 130 with each layer including one or more tubing portions 130.

Similarly, the ends 415 of the tank 100 can be disposed in various suitable locations as described herein, and the enclosure 510, tank mounts 520, interface bracket 530, and the like can be suitably configured accordingly. Therefore, the example enclosure assembly 500 of FIG. 5 should not be construed to be limiting on the wide variety of embodiments of enclosure assemblies 500 that are within the scope and spirit of the present disclosure.

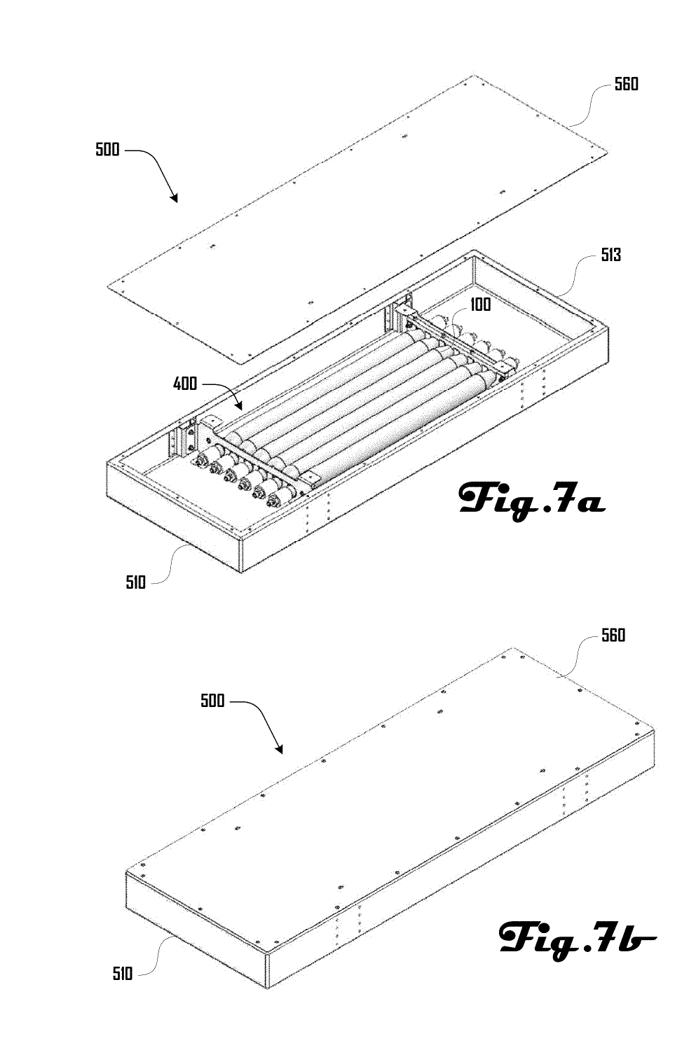

As shown in the example of FIG. 5, the enclosure 510 can comprise a plurality of sidewalls 511, which can include respectively parallel and opposing lateral sidewalls 511L and end sidewalls 511E. The enclosure 510 further includes a base 512 that is shown disposed with the sidewalls 511 extending perpendicularly therefrom. The enclosure 510 can further comprise a rim 513 that extends from a top portion of the sidewalls opposing the base 512. As discussed in more detail herein, the rim 513 can be used for coupling a cover 560 over the enclosure as shown in FIGS. 7a and 7b.

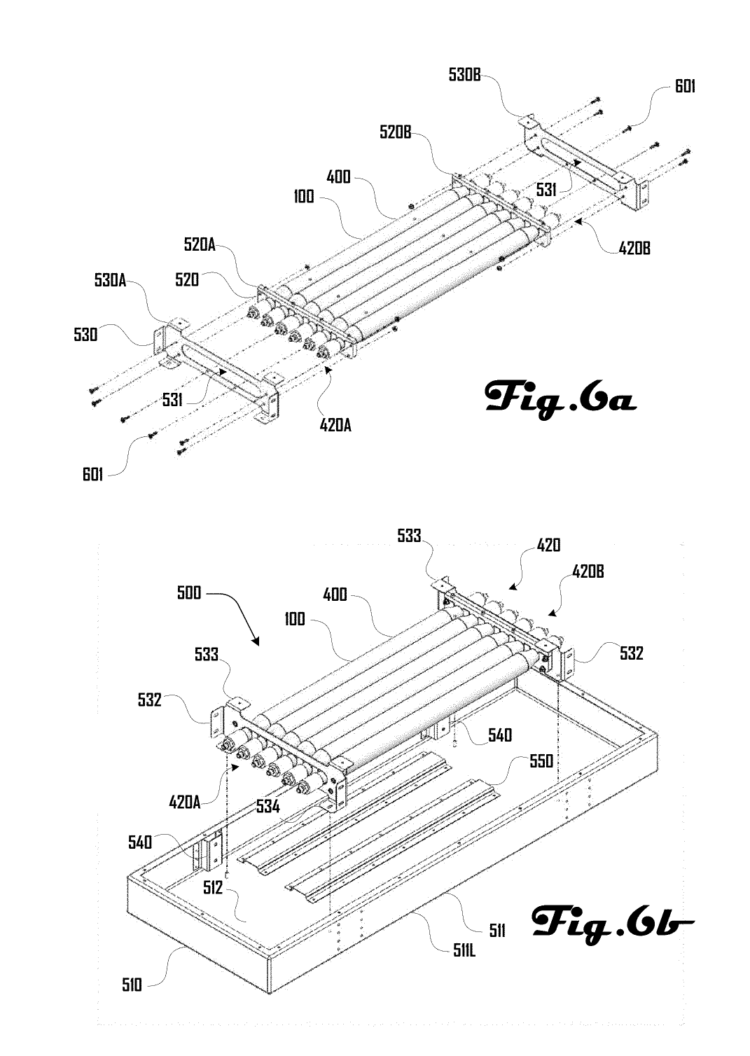

Turning to FIGS. 6a, 6b, 7a and 7b a series of steps of assembling an enclosure assembly 500 are shown. In the examples of FIGS. 6a, 6b, 7a and 7b, a tank 100 having truncated ends is shown for purposes of simplicity; however, it should be clear that any suitable folded tank body 400 can be used to assemble an enclosure assembly 500 as illustrated in FIGS. 6a, 6b, 7a and 7b. For example, in some embodiments, the folded tanks 400 of FIG. 4, 5, 8a-10, 12, 13, 15 or 17 can be included in a portion of an enclosure assembly 500. Accordingly, the examples of FIGS. 6a, 6b, 7a and 7b should not be construed to be limiting on the wide variety of embodiments that are within the scope and spirit of the present disclosure.

FIG. 6a illustrates tank mounts 520 coupled about ends 520 of the tank body 400. More specifically, a first tank mount 520A is coupled about a first end 420A of the tank body 400 and a second tank mount 520B is coupled about a second end 420B of the tank body 400. Interface brackets 530 can be positioned about the ends 520 of the tank body 400 with a portion of the ends 520 extending through respective interface slots 531 of the interface brackets 530. The interface brackets 530 can be coupled to the tank mounts 520 via couplers 601 (e.g., screws, bolts, or the like). More specifically, the first interface bracket 530A can be coupled to a first tank mount 520A with a portion of the first tank body end 420A extending through the interface slot 531 of the first interface bracket 530A. The second interface bracket 530B can be coupled to a second tank mount 520B with a portion of the second tank body end 420B extending through the interface slot 531 of the second interface bracket 530B.

With the interface brackets 530 coupled about the ends 420 of the tank body 400, the tank body 400 can be coupled within the enclosure 510 as shown in FIGS. 6b and 7a. Referring to FIG. 6b, the interface brackets 530 can include a plurality of coupling tabs 532, 533, 534 that can be configured to couple with portions of the enclosure 510. For example, side coupling tabs 532 can couple with fastening brackets 540 disposed on the sidewalls 511 of the enclosure 510. Base tabs 534 can couple with the base 512 of the enclosure 510 and header tabs 533 can couple with a cover 560 (see FIGS. 7a and 7b).

In some embodiments an interface between one or more tank mounts 520 and enclosure 510 can be compliant to allow for movement of the folded tank body 400 inside of the enclosure 510. This can alleviate stress build up and force reactions due to the tank 100 changing shape, (e.g., during pressurization). The interface between one or more tank mounts 520 and the tank 100 can be compliant to allow for slight movements and prevent stress concentrations due to the transition from the portion of the tank 100 that is unconstrained to the portion of the tank 100 that is constrained by the one or more tank mounts 520. Compliance can also help with shock and vibration resistance.

As shown in FIG. 6b, one or more support rails 550 can be disposed on the base 512 of the enclosure 510, which can be configured to support the tubing portions 130 of the tank body 400. In the example of FIG. 6b, support rails 550 are shown extending parallel to the lateral sidewalls 511 and the tubing portions 130 of the tank body 400. However, in further embodiments, one or more support rails 550 can extend perpendicular to the lateral sidewalls 511 and the tubing portions 130 of the tank body 400. Other suitable configurations of support rails 550 are also within the scope of the present disclosure.

Additionally, as shown in FIGS. 7a and 7b, a cover 560 can be coupled to the enclosure 510 via the rim 513 as discussed herein. An interface between the cover 560 and enclosure 510 can be configured in various suitable ways. For example, a hemmed lip on the enclosure 510 and a folded over flange on the cover 560 can be desirable in some embodiments. Such a configuration can reduce the wasted space for joining the two together. The cover 560 and enclosure 510 can be joined with blind rivets (e.g., pop rivets) to reduce the assembly time and reduce the complexity of using threaded fasteners.

In various embodiments, the enclosure assembly 500 can be configured to deflect when impacted by various objects, and it can be desirable to provide for sufficient clearance between the enclosure 510 and the folded tank body 400, in some embodiments, to prevent contact between the enclosure 510 and folded tank body 400 when such a deflection occurs. In examples where the enclosure 510 deflects enough to touch the folded tank body 400, the impact energy can be configured to be mostly absorbed by the enclosure 510 and the impact seen by the folded tank body 400 can be relatively small. The amount of clearance between the enclosure 510 and the folded tank body 400 can be configured based on the material(s) and thickness of various portions of the enclosure assembly 500.

In some embodiments, it can be desirable to emulate manufacturing techniques that stamping allows, but using a forming processes or other suitable manufacturing techniques. Accordingly, in some embodiments, the enclosure can comprise sheet metal, or the like. Weight of some embodiments of an enclosure assembly 500 can be optimized by changing the sheet metal thickness based on a performance characteristic (e.g., to pass UN GT testing, SAE J2579 testing, or the like). Suitable materials for the enclosure assembly 500 in various embodiments can include aluminum, steel, plastic, or the like. In some examples, an enclosure assembly 500 can be made of plastic through processing such as rotational molding; can be made from fiber reinforced composites such as chopped strand mat, sheets using resin transfer molding, prepreg, etc.; or the like. Some enclosure assembly 500 embodiments can include finishing to protect against the elements. For example, an e-coat plus paint finishing, or the like, can be suitable in various embodiments.

Heat and fire resistance of an enclosure assembly 500 can also be desirable. For example, in some embodiments, the enclosure assembly 500 can comprise an intumescent coating and/or material. Further embodiments of an enclosure assembly 500 can comprise ceramic blanket insulation, graphite blanket insulation, silica blankets, Aero-Gel, or the like. In some embodiments, it can be desirable to use fireproofing insulation with the enclosure assembly 500. If insulation is used, the melting of the enclosure assembly 500 may not be a significant concern in various embodiments. Even without the use of insulation, the enclosure assembly 500 can be configured to vent the tank 100 before the enclosure assembly 500 and/or tanks 100 are compromised.

One embodiment of the enclosure assembly 500 can comprise steel with or without studs for tank mounting, and another embodiment can comprise aluminum with or without studs (e.g., for observation in a fire test or the like). Various embodiments of the enclosure assembly 500 may or may not have chambers. Some embodiments of the enclosure assembly 500 can contain sensors to monitor the internal and/or external environment (e.g., the effects a bonfire test or working conditions).

In various embodiments the enclosure assembly 500 can be configured based on desired heat tolerance. Accordingly, one or more of the following can be used in determining a desirable configuration and/or material for the enclosure assembly 500: melting point of aluminum just above 600 C; melting point of steel not a concern; and emissivity of steel greater than that of aluminum.

An enclosure assembly 500 can be made in various suitable ways. For example, one embodiment of an enclosure assembly 500 design can comprise two stamped pieces of aluminum. A flange on both the enclosure 510 and cover 560 of the enclosure assembly 500 can be used to fasten the enclosure 510 and cover 560 together. Additionally, some embodiments can seal such flange(s) and any other coupling between the enclosure 510 and cover 560. For example, a bead of silicon (e.g., Room Temperature Vulcanization silicone (RTV)), or the like can be used to prevent unwanted dirt, water, or other substances from entering the enclosure assembly 500.

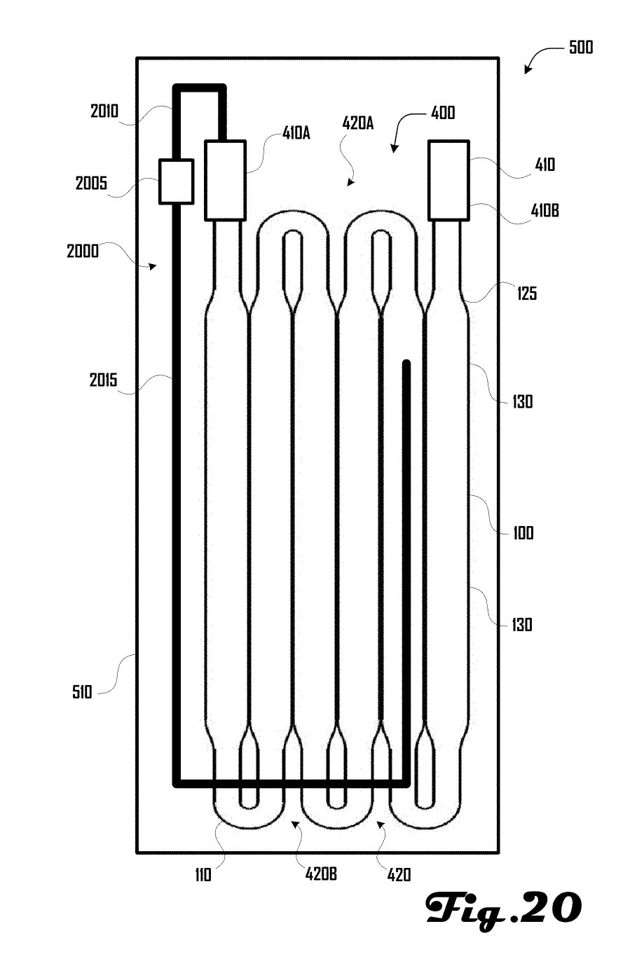

In various embodiments, temperature can be considered in the design of an enclosure. For example, a thermally-activated pressure relief device (TPRD) can be associated with the enclosure assembly 500 to provide for pressure release where temperature associated with the tank 100 has reached an activation temperature. For example, as illustrated in FIG. 20, an enclosure assembly 500 can comprise a TPRD assembly 2000 that includes a TPRD 2005 coupled to a first coupler 410 of the folded tank body 400 with a trigger line 2015 extending from the TPRD 2005. In various embodiments, the trigger line 2015 can be routed around the enclosure 510 with a heat-sensitive element inside of the trigger line 2015. For example, if such a heat-sensitive element reaches a temperature threshold (e.g., from exposure to fire), the heat-sensitive element can contract and open the TPRD 2005 to vent fluid disposed in the tank 100.

As shown in FIG. 20, the trigger line 2015 can extend along a length of the folded tank body 400 from the TPRD 2005 toward the second end 420B and then curve perpendicularly to the length of the folded tank body 400 and then curve back along the length of the folded tank body 400 toward the first end 420A. Such a configuration of a trigger line 2015 can be desirable so that the trigger line 2015 can be exposed to a variety of locations within the enclosure assembly 500 so that the temperature of many locations of the enclosure assembly 500 can be monitored.

The activation temperature of the TPRD, time to vent tank pressure through the TPRD, and an amount of heat insulation provided an air gap within the enclosure assembly 500, and the like, can be factors for configuring an enclosure assembly 500. In some embodiments, further insulating materials, in addition to an air gap, may or may not be desirable within the enclosure assembly 500. To prevent catastrophic failure to the enclosure in the event of over-pressurization, rupture/burst disks can be included in the enclosure assembly 500 to rapidly vent the enclosure assembly 500. The enclosure assembly 500 can comprise perforated sheet or wire mesh to prevent unwanted pressure build-up inside of the enclosure assembly 500 to prevent catastrophic failure.

In some embodiments, an enclosure assembly 500 can be configured for ballistic resistance. In some embodiments, components of an enclosure assembly 500 can comprise a single material type and some embodiments can comprise a plurality of material types. For example, one embodiment can include sandwiching a lightweight, energy absorbing material (such as ultra-high-molecular-weight polyethylene or UHMW) between sheets of metal or fiberglass reinforced plastic (FRP), Kevlar, carbon, glass, or the like. Further embodiments can comprise polyurethane/polyuria.

Ballistic resistance of an enclosure assembly 500 and/or tanks 100 of an enclosure assembly 500 can be desirable in various embodiments. For example, such ballistic resistance can be configure to provide for passing rating tests (e.g., SAE J2579 and the like) for the enclosure assembly 500, and also for preventing undesirable damage to the enclosure assembly 500 and/or tank 100 of the enclosure assembly 500 while in use. While some embodiments can be configured to stop a bullet, some embodiments can be configured to absorb energy during the impact of a bullet, even if partial or complete penetration occurs. Accordingly, removing kinetic energy from a bullet after passing through the various materials of an enclosure assembly 500 can be desirable for preventing damage to the enclosure assembly 500 and/or tank 100 of the enclosure assembly 500. Some embodiments can comprise a stainless steel mesh/polyurea coating composite.

For ballistic resistance and/or passing ballistic resistance tests, an enclosure assembly 500 can be configured in various suitable ways to affect incoming ballistic fire. Such configurations can be configured for one or more of: changing the effects of the bullet itself (e.g., slowing the bullet down effectively enough that it can minimize damage on the tank 100); changing the behavior of the tank 100 in the event of a rupture (e.g., coatings, foam fillers, or the like that encapsulate the tank 100 so the behavior of a rupture can be shaped into that of a leak; surround the tank 100 with a tough, closed cell foam that contains the rupture, and allows the gas to vent out of the bullet's penetration hole); and containing the rupture of the tank 100, and channeling the escaping gas in such a fashion that it mimics a leak.

In ballistics, a first material is directly in the line of fire, and behind the first material is what is known as a “witness plate.” In various embodiments, the effectiveness of (and sometimes the damage to) the first material in is judged by the patterns and severity of damage to the witness plate. In some embodiments the enclosure assembly 500 can comprise a witness plate, which in some examples can comprise a flat square of composite and liner material, which can further comprise a piece of paper or clay in front of it to witness any spalling or shrapnel. In some embodiments, multiple layers of witness plates can be desirable.

Bulletproofing or ballistic resistance of an enclosure assembly 500 and/or tank 100 of the enclosure assembly 500 can be rated in various ways, including classification systems bulletproofing a person and bulletproofing a structure or thing. For example, in some embodiments, the enclosure and/or tank can be rated to meet or exceed National Institute of Justice (NIJ) code 0101.06; Underwriters Laboratory standard UL-752 (e.g., any of levels 1-10); and the like. Accordingly, some embodiments of an enclosure assembly 500 can comprise hardened steel (e.g., ½″ thick heat treated steel, AR500 steel, or the like); about 2″ thick solid ultra-high molecular weight polyethylene (UHMWPE), ceramic, Dyneema/spectra panels, Kevlar, an auxetic fabric, graphene, Aluminum oxynitride, or the like. Further embodiments can comprise hard armor plates. In some embodiments, ceramic can be backed with a fabric woven out of Spectra, Kevlar, or the like. Spectra, Dyneema, or UHMWPE panels can comprise several layers of woven fabric, laid into a composite. In such embodiments, the fibers can be really tough and hard to break through, and much of the bullet's energy is spent in de-laminating each layer away from the resin. Additionally, various materials can comprise a ballistic spray-on coating. As discussed herein, various embodiments can incorporate a protective shell around the tank and its mounting hardware. This shell enclosure can shield the composite from impact, abrasion, heat, and the like. The configuration of the shell can be configured for various sizes and configurations of the tank 100.

An enclosure assembly 500 and/or tank 100 of the enclosure assembly 500 described herein can be used for storing various types of fluids, including fluids comprising hydrogen, CNG, air, or the like. Accordingly, various embodiments can be suitably configured to store various types of fluids under suitable pressure.

Some embodiments can include one or more of: 5052-H32 aluminum; removable tank mount interface brackets; clinch nuts & clinch studs to secure tank to enclosure; stiffener hat sections welded to the enclosure 510 and cover 560; cover 560 secures to a box flange using fasteners & clinch nuts; and black anodized portions for corrosion resistance. An enclosure assembly 500 can be manufactured in various suitable ways as discussed herein. For example, in some embodiments, various components of an enclosure assembly 500 can be laser cut from an aluminum sheet. Various embodiments can include brake bent aluminum sheet metal of various thicknesses including some in the range of 1.0 mm-4.1 mm, including preferred embodiments of 3.1 mm thick, 2.0 mm thick, and 1.6 mm thick. Seams can be welded (e.g., continuous on any non-bent enclosure edges). Hat section stiffeners can be plug welded. Clinch nuts and clinch studs can be pressed into the enclosure 510. Attachment features can be riveted to the enclosure 510 (e.g., via aluminum blind rivets, or the like).

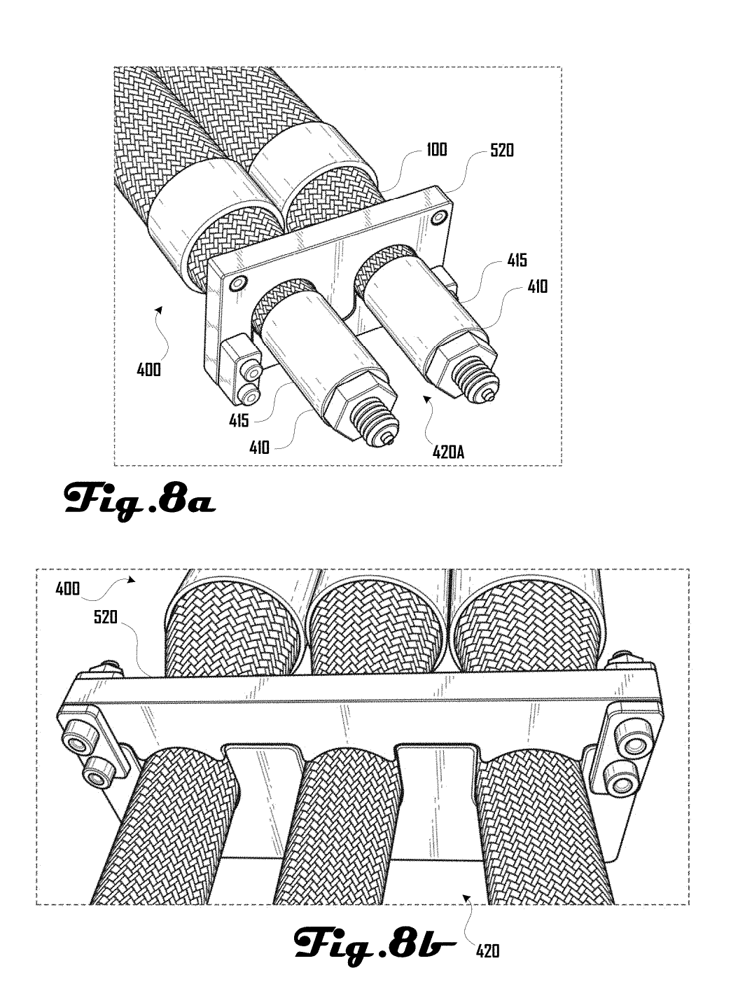

Turning to FIGS. 8a, 8b, 9 and 10, example embodiments of a folded tank body 400 and tank mounts 520 are illustrated. For example, FIG. 8a illustrates a tank mount 520 configured for coupling about ends 415 of a tank 100, including fittings 410 coupled at the ends 415. FIG. 8b illustrates a tank mount 520 configured to couple about three portions of a folded tank body 400 at an end 420 of the tank body 400.

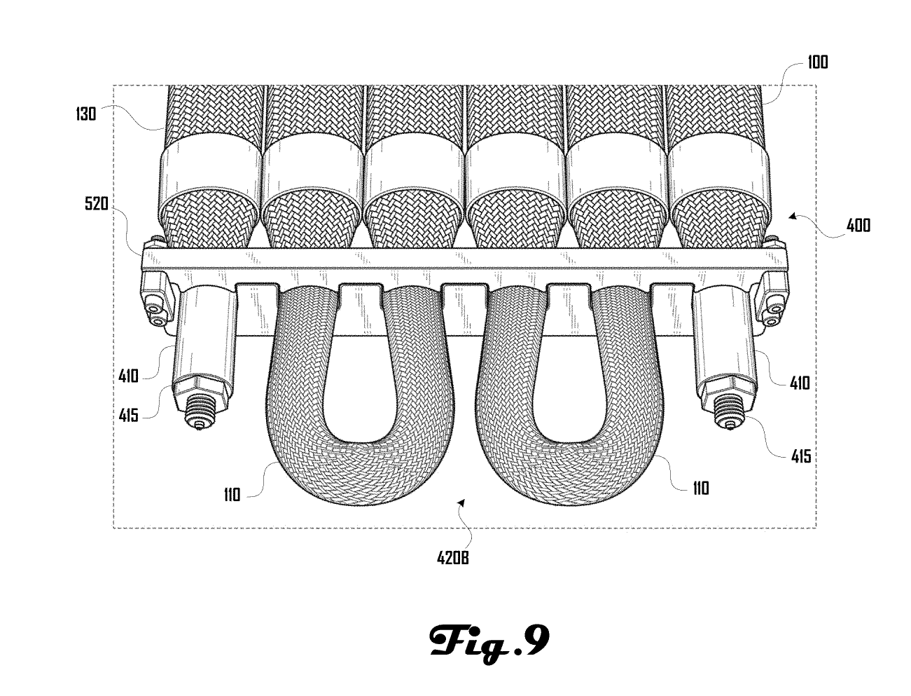

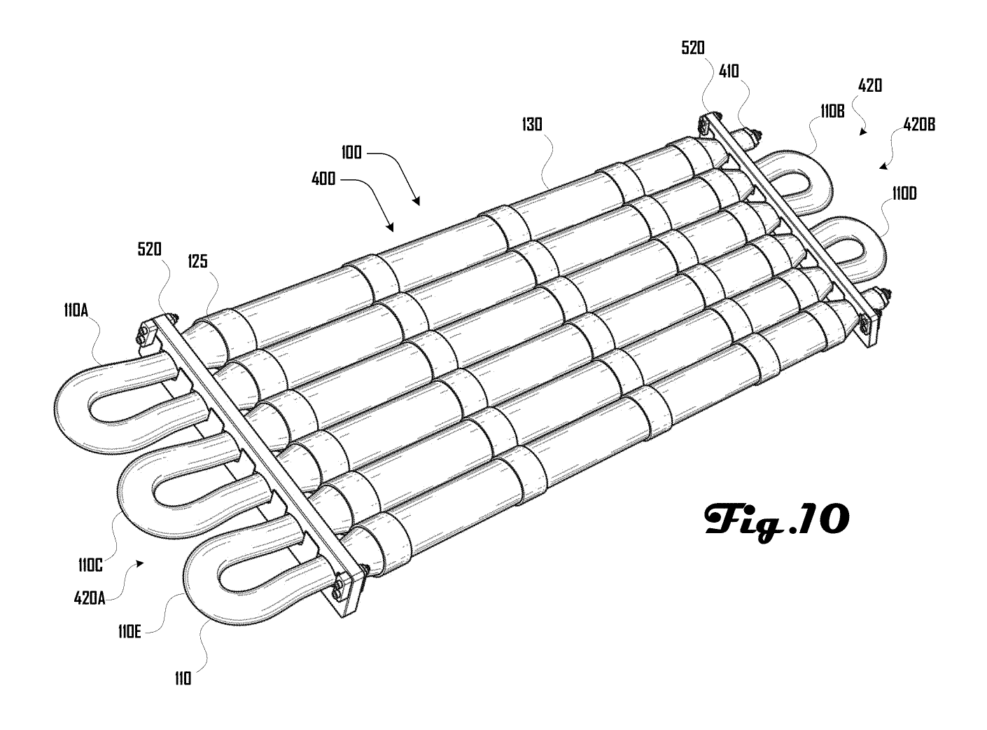

FIG. 9 is a close-up view of a second end 420B the folded tank body 400 shown in FIG. 10, including a tank mount 520 configured to couple about six portions of the second end 420B of the folded tank body 400. Specifically, the tank mount 520 shown in FIG. 9 is shown coupling about the ends 415 of a tank 100 having fittings 410 coupled at the ends 415. Additionally, the tank mount 520 is shown coupled about two separate portions of two curved connector portions 110 at the second end 420B of the folded tank body 400. Additionally, as shown in FIG. 10 the tank mount 520 coupled about the first end 420A of the folded tank body 400 is shown coupled about two separate portions of three curved connector portions 110 at the first end 420A of the folded tank body 400. In some embodiments, edges or portions of tank mounts 520 in direct contact with the tank 100 can be rounded (e.g., using a table router or the like). Rounding the edges can prevent damage to a wet braid during production, can avoid cutting of reinforcing fibers as the tank expands during pressurization, and the like.

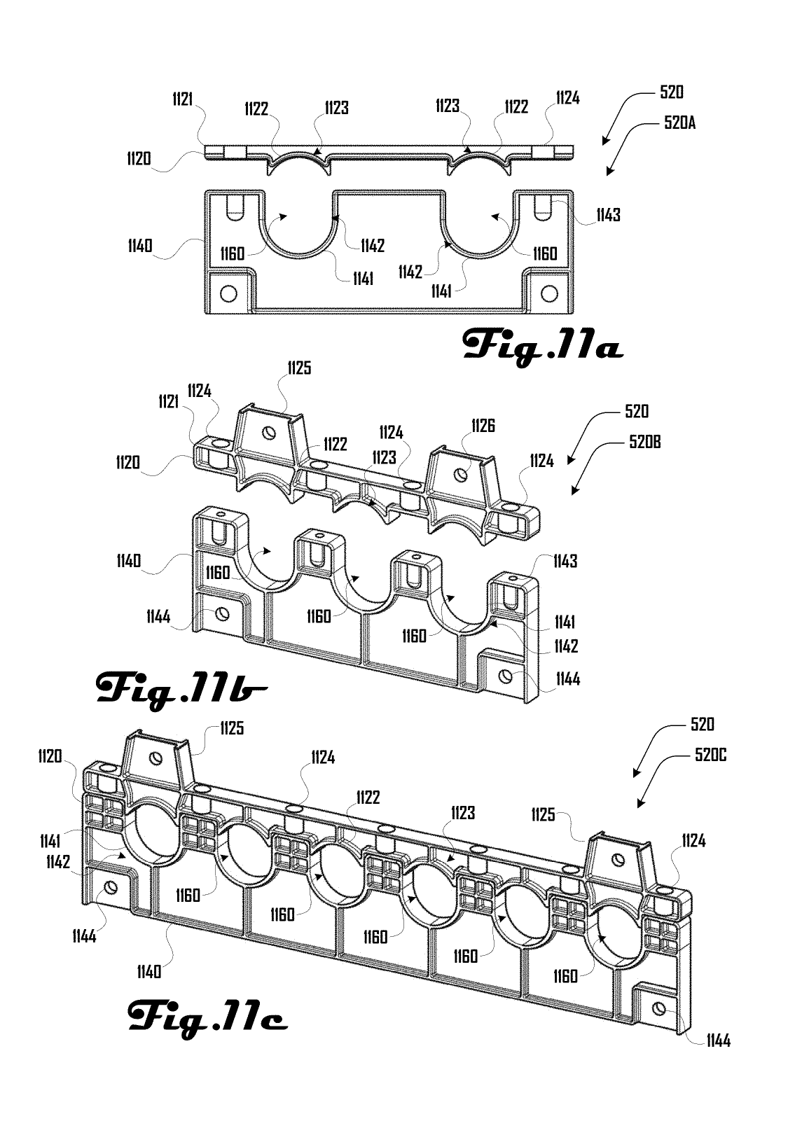

Turning to FIGS. 11a, 11b and 11c, three example embodiments of tank mounts 520 are illustrated. More specifically, a two-portion coupling tank mount 520A is shown in FIG. 11a; a three-portion coupling tank mount 520B is shown in FIG. 11b; and a six-portion coupling tank mount 520C is shown in FIG. 11c.

FIG. 11a illustrates an embodiment 520A of a tank mount 520 that includes a mount cap 1120 and a separate mount base 1140. The mount cap 1120 includes a main cap body 1121 with two coupling flanges 1122 that define two respective mount cap coupling slots 1123. The mount base 1140 includes two coupling rims 1141 that define respective mount base coupling slots 1142. The mount cap 1120 and mount base 1140 can couple such that the mount cap coupling flanges 1122 extend into the mount base coupling slots 1142 to collectively define two respective tank mount coupling holes 1160.

Additionally, the mount cap 1120 can comprise one or more coupling structures 1124, and the mount base 1140 can also include one or more coupling structures 1143. For example, in various embodiments, the respective coupling structures 1124, 1114 can be aligned when the mount cap 1120 and mount base 1140 are coupled together, and a coupler such as a screw, pin, bolt, or the like can engage with the respective paired coupling structures 1124, 1114 to fix the mount cap 1120 and mount base 1140 together. In further embodiments, the mount cap 1120 and mount base 1140 can be fixed together in various suitable ways, including via a friction fit, adhesive, or other suitable structure or coupling method.

FIG. 11b illustrates another embodiment 520B of a tank mount 520 that includes a mount cap 1120 and a separate mount base 1140. The mount cap 1120 includes a main cap body 1121 with three coupling flanges 1122 that define three respective mount cap coupling slots 1123. The mount base 1140 includes three coupling rims 1141 that define three respective mount base coupling slots 1142. The mount cap 1120 and mount base 1140 can couple such that the mount cap coupling flanges 1122 extend into the mount base coupling slots 1142 to collectively define three respective tank mount coupling holes 1160.

FIG. 11c illustrates another embodiment 520C of a tank mount 520 that includes a mount cap 1120 and a separate mount base 1140. The mount cap 1120 includes a main cap body 1121 with six coupling flanges 1122 that define six respective mount cap coupling slots 1123. The mount base 1140 includes six coupling rims 1141 that define six respective mount base coupling slots 1142. The mount cap 1120 and mount base 1140 can couple such that the mount cap coupling flanges 1122 extend into the mount base coupling slots 1142 to collectively define six respective tank mount coupling holes 1160. As shown in FIGS. 11b and 11c, in some embodiments, the mount cap 1120 can comprise tabs 1125, which can include tab holes 1126.

Although example embodiments 520A, 520B, 520C illustrate examples of tank mounts 520 respectively having two, three, and six tank mount coupling holes 1160, further embodiments can include any suitable number of tank mount coupling holes 1160, including one, four, five, seven, eight, nine, ten, twelve, fifteen, twenty, thirty, forty, fifty, or the like. Tank mounts 520 can be configured to fit inside an enclosure 510 of an enclosure assembly 500, and can be made in various suitable ways including with reamed holes, shoulder bolts, threaded inserts, helical inserts, and the like.

A tank mount 520 can be configured in various suitable ways and can be made of any suitable material, including metal, plastic, a polymer, or the like. In one example, a tank mount 520 can comprise 0.5″ aluminum plates held together by stainless steel screws. The aluminum plates can be cut to size using a waterjet, or the like, in some examples. Another example can include an injection molded plastic tank mount comprising fiber-filled nylon. Such an embodiment can comprise a 30% long glass fiber filled nylon, which can be desirable for elevated temperature performance, improved strength, stiffness, and the like. Such embodiments can use various suitable methods for producing tank mounts 520 at desirable required volumes. Further examples can secure the tank mount 520 within the enclosure assembly 500 without the use of fasteners, which can improve assembly time, potentially reduce the cost, simplify the system, or the like. For example, this can be done with a hook-snap type feature, or the like. Such tank mount designs can cut down on the weight relative to other designs.

One embodiment of a tank mount 520 can comprise injection molded plastic (e.g., glass-fiber filled nylon). Such an embodiment can offer benefits on cost, manufacturing, isolation of carbon tanks from an aluminum enclosure (galvanic), and the like. In various embodiments tank mounts 520 can be made via hollow extrusion, which can be desirable for light-weighting.

During production, one or more tank mount 520 can act as a fixture to form, locate, and constrain a flexible tank 100 into a folded tank body 400, which can determine the final geometry of the tank folded tank body 400 in some embodiments. For example, a resin can be applied to a flexible tank 100 (see, e.g., related U.S. patent application Ser. No. 15/368,182, filed Dec. 2, 2016, entitled Systems And Methods For Liner Braiding And Resin Application, which is incorporated herein as cited above), and the flexible tank 100 can be fitted with tank mounts 520 to constrain the flexible tank 100 into a folded tank body 400 while the resin cures and hardens. Once the resin cures and hardens, the previously flexible tank 100 can be substantially fixed as the folded tank body 400. The folded tank body 400, fixed in position with the cured resin, can be disclosed in the enclosure 510.

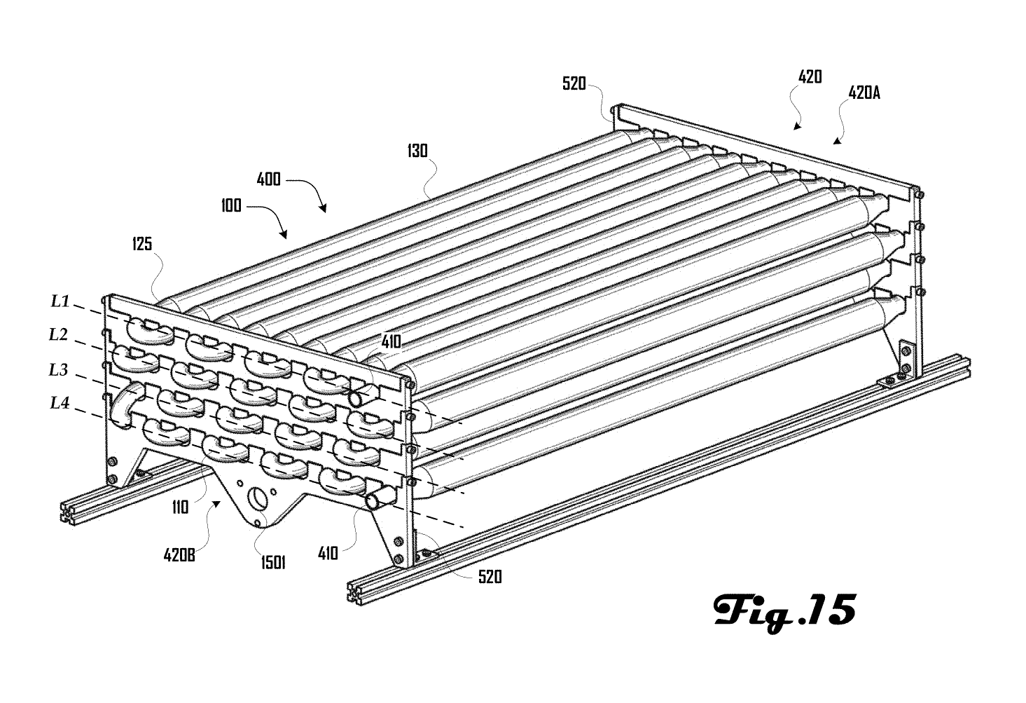

In some embodiments, one or more tank mount 520 can support the weight of a wet resinated tank 100 and can attach to a rotisserie inside an oven (see, e.g., via a rotisserie mount 1501 of FIG. 15) allowing the tank 100 to rotate during curing to avoid resin pooling. Materials for tank mounts 520 can be selected to withstand a maximum curing temperature (e.g., 140° C. (285° F.) or the like).

During use of the tank 100 (e.g., as a fuel tank in a vehicle), tank mounts 520 can continue to support the weight of the tank 100. As the tank 100 is pressurized, the tank mounts 520 can restrain the expanding tank 100 and prevent the bent sections of the connector portions 110 of the tank 100 from straightening. Also, the tank mounts 520 can function as a connection interface between the tank 100 and a vehicle frame or chassis. The tank mounts 520 can isolate the tank 100 from vibration and impact forces, and can provide attachment points for an additional protective shell. As an in-service component, the tank mounts 520 can also be configured to resist chemical exposure, UV exposure, heat exposure, ballistic exposure, and the like.

In some embodiments, a tank mount can interface with the bent corrugations 111 and/or the taper portions 125 of a tank 100 to resist unbending forces as close as possible to their source. In other embodiments, a tank mount 520 can comprise a two dimensional shape that constrains a straight length of corrugation 111 between a bent corrugation 111 and taper portion 125. One or more tank mounts 520 can be permanently attached to the tank 100 during the curing process and cannot be removed, but in further embodiments, the one or more tank mounts 520 can be removable.

In further embodiments, various features can support the end-fittings 415 of a tank 100 during the curing process. For example, rails can be added to the top of the tank 100 for protection during shipping and to allow easier handling of the finished product. In various embodiments, tank mounts 520 can be used for curing (e.g., configure chambers and support weight during cure); service (e.g., resist unbending force during pressurization); and in an enclosure system (e.g., to interface between composite and enclosure).

In some embodiments, circular openings of a tank mount 520 can interface with small diameter tank sections (e.g., cuff 115 and/or corrugations 111). For example, the tank mount 520 can be configured to mount at a tank taper 125 (e.g., shorter overall length) and/or at a tank bend of a connector portion 110 (e.g., tighter corrugation bend radius). A taper locating tool can used to find the tank taper 125 and position it properly relative to the tank mount 520.

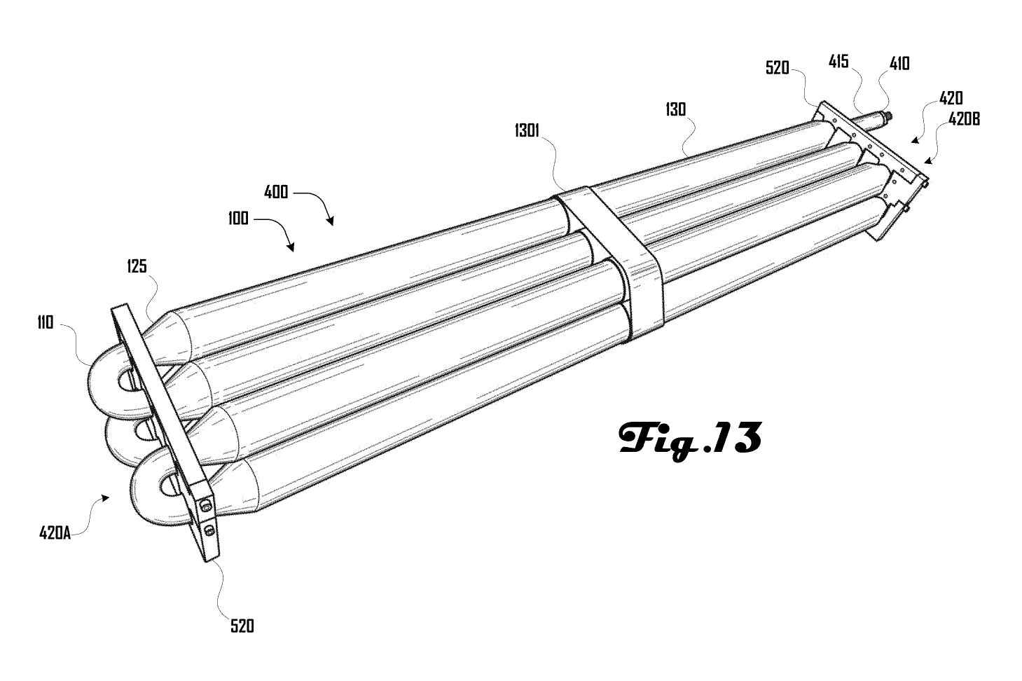

The tubing portions 130 of a tank can be spaced in various suitable ways by one or more tank mounts 520. For example, in one embodiment, tape (e.g., 1 mm thick silicone tape) can be wrapped around the chamber to provide for separation. For example, FIG. 13 illustrates an example where tape is disposed about tubing portions 130 of a tank 100. Spacing can be desirable in various embodiments because the tubing portions 130 can bow out of alignment in some embodiments during fill events and at other times when the tank 100 is pressurized or depressurized.

Additionally, in some examples, a folded tank body 400 can have substantially the same tank mounts 520 coupled on the ends 420 of the folded tank body 400 or tank mounts 520 having the same number of tank mount coupling holes 1160. For example, FIG. 10 illustrates an example embodiment having substantially the same tank mounts 520 coupled on the ends 420 of the folded tank body 400 with both tank mounts 520 having six tank mount coupling holes 1160. However, in some embodiments, tank mounts 520 associated with a folded tank body 400 can be configured differently, including having a different number of tank mount coupling holes 1160.

Also, in various embodiments, tank mounts 520 can be configured to couple about portions of connector portions 110 (e.g., as shown in FIG. 10), but in further embodiments, tank mounts 520 can be configured to couple with tubing portions 130. Additionally, in some examples, tank mounts 520 can be configured to couple about taper portions 125 of a tank 100 and the tank mount coupling holes 1160 can have sloped sidewalls to correspond to the taper portions 125. Also, various examples illustrate a folded tank body 400 having a first and second tank mount 520A, 520B coupled about first and second ends 420A, 420B of the folded tank body 400. However, in some embodiments, a single tank mount 520 can be coupled with a folded tank body 400 or any suitable plurality of tank mounts 520 can be coupled with a folded tank body 400, including three, four, five, six, seven, eight, nine, ten, fifteen, twenty, thirty, fifty, or the like. Additionally, in some embodiments, the folded tank body 400 can include a tank body wrap 1301 (FIG. 13), which can including a wrapping about the tubing portions 130 of the folded tank body 400, which can be desirable for securing the tubing portions 130 together and preventing movement thereof.

Although various examples herein include folded tank bodies 400 that define a single layer of tubing portions 130 (e.g., FIGS. 4-10), in further embodiments a folded tank body 400 can define a plurality of layers of tubing portions 130 as described in more detail herein. Tank mounts 520 and enclosure assemblies 500 can be configured for such multi-layer folded tank bodies 400.

Turning to FIGS. 12 and 13, an example folded tank body 400 is illustrated having two layers of tubing portions 130 with each layer having three tubing portions 130. In the exploded view of FIG. 12 and in the assembled view of FIG. 13, a pair of tank mounts 520 are shown about the first and second ends 420A, 420B of the folded tank body 400, which can be configured to couple about connector portions 110 of the tank 100.

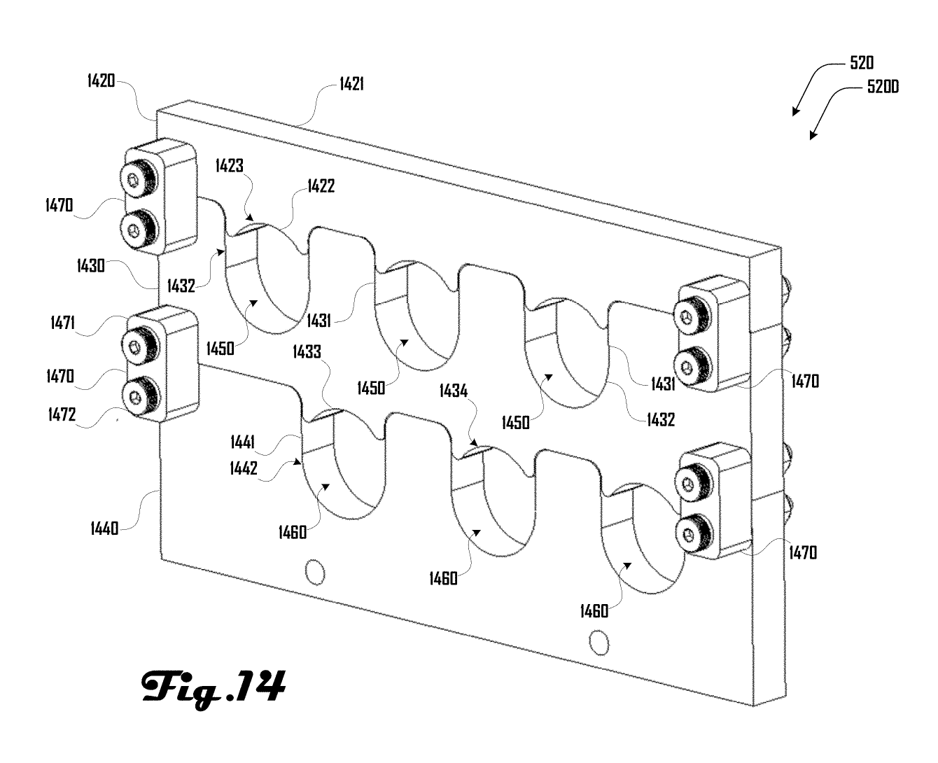

As shown in FIG. 14, the tank mounts shown in FIGS. 12 and 13 can comprise a tank mount top unit 1420, a tank mount middle unit 1430 and a tank mount bottom unit 1440. The tank mount top unit 1420 includes a main body 1421 with three coupling flanges 1422 that define three respective top unit coupling slots 1423. The tank mount middle unit 1430 includes three coupling rims 1431 that define respective middle unit coupling slots 1432. The tank mount top unit 1420 and mount middle unit 1430 can couple such that the mount top unit coupling flanges 1422 extend into the middle unit coupling slots 1142 to collectively define a first set of three respective tank mount coupling holes 1450.

The tank mount middle unit 1430 further includes three coupling flanges 1433 that define three respective middle unit coupling slots 1434. The tank mount middle unit 1430 and mount bottom unit 1440 can couple such that the middle unit coupling flanges 1433 extend into bottom unit coupling slots 1442 defined by coupling rims 1441 of the mount bottom unit 1440. Such a coupling can collectively define a second set of three respective tank mount coupling holes 1460.

As shown in FIGS. 12 and 13, portions of a first layer of the folded tank body 400 can be disposed within the first set of tank mount coupling holes 1450 and portions of a second layer of the folded tank body 400 can be disposed within the second set of tank mount coupling holes 1460. The tank mount top unit 1420, tank mount middle unit 1430, and tank mount bottom unit 1440 can be coupled via mount bar assemblies 1470 that include a mount bar 1471 that extend between respective adjoining units 1420, 1430, 1440 and are coupled thereto via bolts 1472. As discussed herein, tank mount top unit 1420, tank mount middle unit 1430, and tank mount bottom unit 1440 can be coupled in various alternative suitable ways, and the example of a mount bar assembly 1470 should not be construed to be limiting.

As discussed herein, further embodiments of folded tank bodies 400 can include any suitable number of layers, with any suitable number of tubing portions 130 per layer. In some embodiments, all layers can have the same number of tubing portions 130, whereas in some embodiments, some layers can have a different number of tubing portions 130. For example, as discussed herein, FIGS. 12 and 13 illustrate one example of a folded tank body 400 having two layers with three tubing portions 130 per layer.

FIG. 15 illustrates another example of a folded tank body 400 having four layers L1, L2, L3, L4 which includes nine tubing portions 130 in the first layer L1 and third layer L3, and ten tubing portions 130 in the second layer L2 and fourth layer L4. In this example, both ends 410 of the tank 100 are disposed at a second end 420B of the folded tank body 400, with no ends 410 disposed at a first end 420A of the folded tank body 400. A pair of tank mounts 520 are respectively disposed at the first and second ends 420A, 420B of the folded tank body 400.

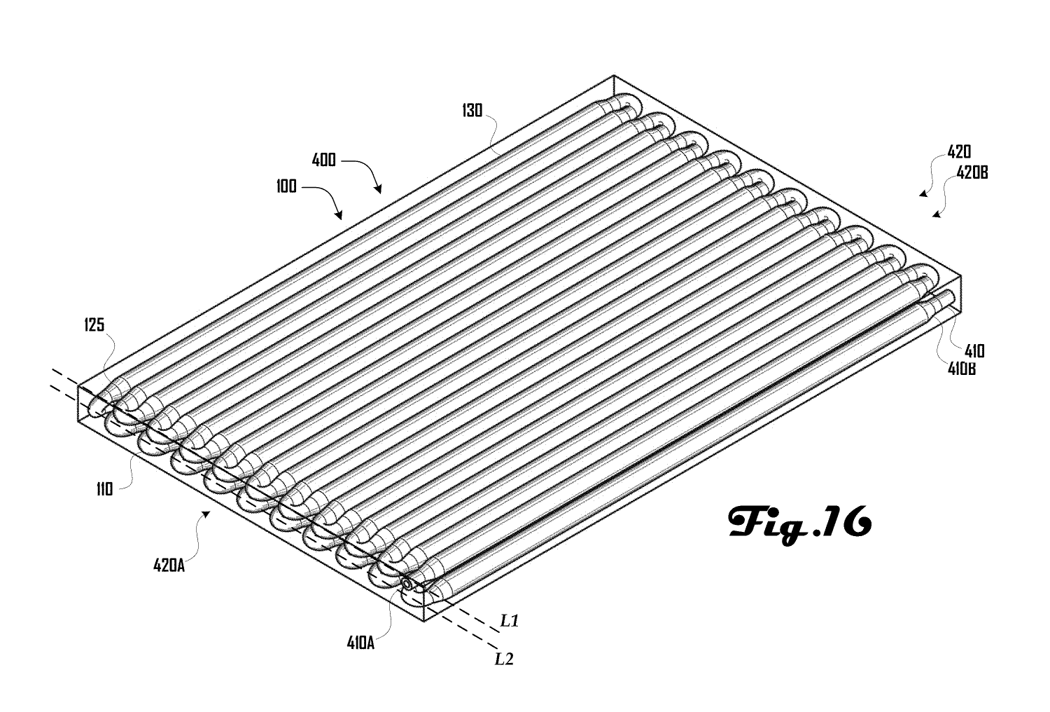

FIG. 16 illustrates a further example of a folded tank body 400 having two layers L1, L2 which include twenty tubing portions 130 in the first layer L1 and twenty-one tubing portions 130 in the second layer L2. In this example, a first end 410A of the tank 100 is disposed at a first end 420A of the folded tank body 400, with a second end 410B disposed at a second end 420B of the folded tank body 400.

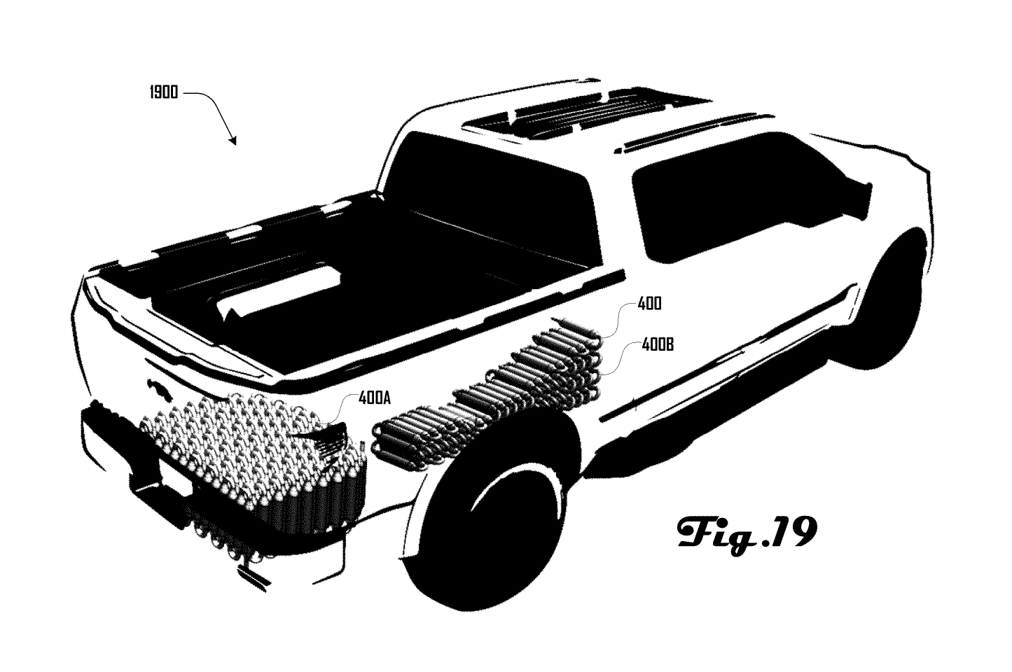

While various examples disclosed herein include folded tank bodies 400 forming a generally planar or rectangular prism configuration, further examples can include one or more folded tank body 400 having any suitable regular or irregular configuration. For example, as shown in FIG. 19, a plurality of folded tank bodies 400 can be configured to be coupled with a vehicle 1900 and can include tank bodies 400 having irregular shapes, which can be desirable in some embodiments to provide for fitting a folded tank body 400 and/or enclosure within irregularly shaped portions of the vehicle 1900. More specifically, a first folded tank body 400A is shown defining a shape having rounded edges. A second tank body 400B is shown having a plurality of rows having of a varying number of tubing portions 130 and with some rows being non-contiguous. A tank enclosure assembly 500 and components thereof can accordingly be modified to accommodate folded tank bodies 400 having any suitable regular or irregular shape. In other words, it should be clear that while some examples of a tank enclosure assembly 500 herein include a generally planar or rectangular prism configuration, further embodiments of a tank enclosure assembly 500 can be any suitable regular or irregular shape including curved shapes, and the like.

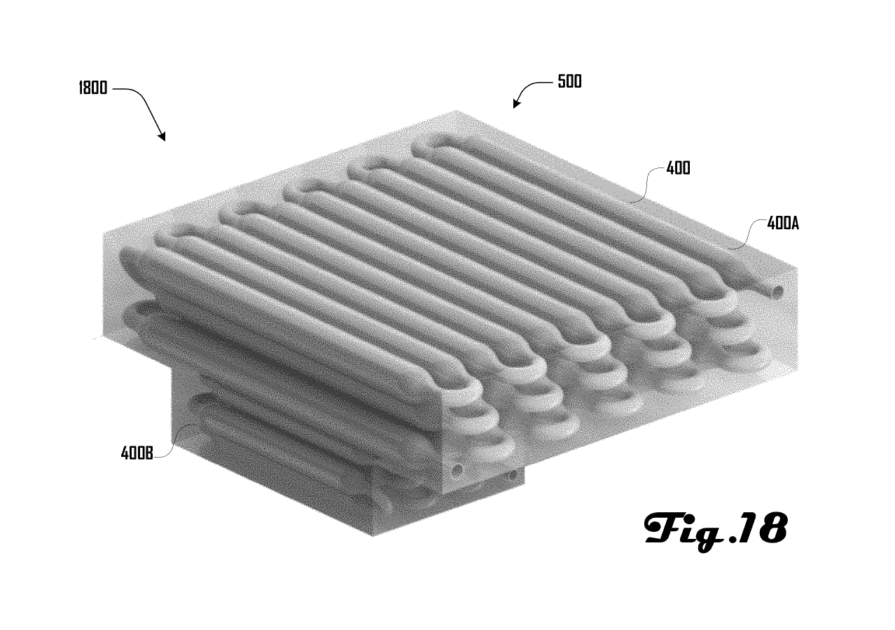

Additionally, while various examples disclosed herein relate to a single folded tank body 400 being disposed within a tank enclosure assembly 500, further examples can comprise and suitable plurality of folded tank bodies 400 disposed within a tank enclosure assembly 500. For example, FIG. 18 illustrates one example where a first tank body 400A and second tank body 400B are disposed within a tank enclosure assembly 500.

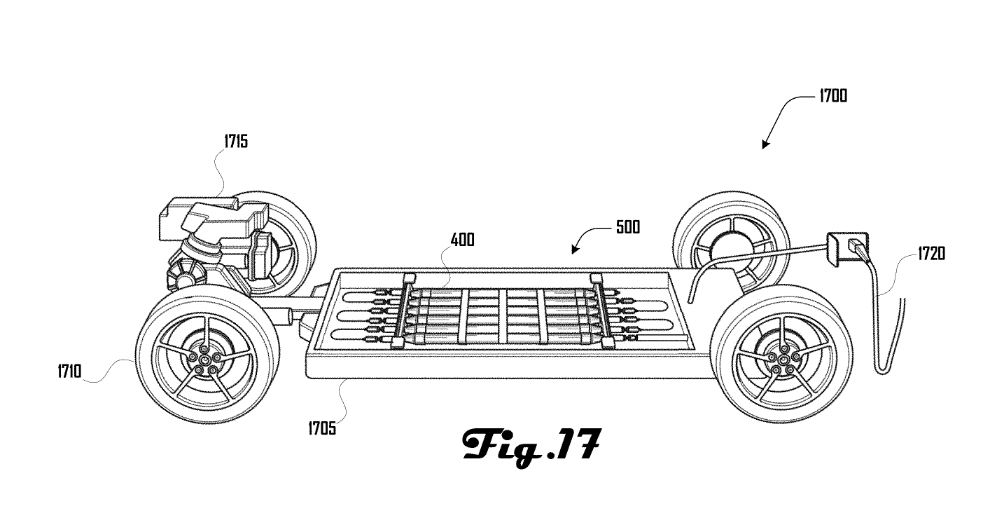

A tank enclosure assembly 500, as discussed herein, can be configured for various suitable uses, including as a fuel tank for vehicles. For example, FIG. 17 illustrates an example of a vehicle 1700 of one embodiment that includes a tank enclosure assembly 500 coupled to the chassis 1705 of the vehicle 1700. More specifically, the tank enclosure 500 in this example is shown coupled to the chassis 1705 of the vehicle 1700 between the wheels 1710 and defining a portion of the undercarriage of the vehicle 1700. The folded tank body 400 can store a fuel fluid (e.g., hydrogen, liquid natural gas, and the like), which can be provided to and power the engine 1715 of the vehicle 1700. The folded tank body 400 can be refilled by a re-fueling line 1720, which can be removably coupled with the vehicle 1700 for re-fueling at a re-fueling, user residence or other suitable location.

In various embodiments, a tank enclosure assembly 500 can define a structural component of a vehicle. For example, the tank enclosure assembly 500 can serve to protect a folded tank body 400 and provide the vehicle structural rigidity, protection of an underbody of the vehicle, and the like. In some examples, the tank enclosure assembly 500 can define an integral portion of a vehicle such that the vehicle would be effectively inoperable, lack structural stability, or would otherwise be substantially structurally affected if the tank enclosure assembly 500 was absent or removed.

Additionally, as discussed herein, any suitable tank enclosure assembly 500 and any suitable folded tank body 400 can be configured for use with various vehicles, with the folded tank body 400 having any suitable number and configuration of layers and number of tubing portions 130 per layer as discussed herein. Such a configuration can, in some embodiments, be based at least in part on the size of the chassis of the vehicle, the desired diameter of the tubing portions 130, the desired volume of the folded tank body 400, the desired and potential ground clearance of the vehicle, and the like. For example, as discussed above and as shown in FIG. 19, in some examples, one or more enclosure assembly 500 can comprise one or more folded tank body 400, with the enclosure assemblies 500 and/or folded tank bodies 400 defining any suitable regular or irregular shape.

Also, tubing portions 130 can extend between ends 420 of a folded tank body 400 in various suitable ways relative to a vehicle or the ground. For example, FIG. 17 illustrates tubing portions 130 of the folded tank body 400 extending parallel to the ground and perpendicular to axels of the vehicle 1700. In contrast, the first folded tank body 400A of FIG. 19 illustrates tubing portions 130 of the first folded tank body 400A extending perpendicular to the ground. The second folded tank body 400B of FIG. 19 illustrates tubing portions 130 of the second folded tank body 400B extending parallel to axels of the vehicle 1900.

The described embodiments are susceptible to various modifications and alternative forms, and specific examples thereof have been shown by way of example in the drawings and are herein described in detail. It should be understood, however, that the described embodiments are not to be limited to the particular forms or methods disclosed; but to the contrary, the present disclosure is to cover all modifications, equivalents, and alternatives.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

What is claimed is:

1. A method of constructing an enclosure assembly including a folded tank body, the method comprising:
applying resin to an elongated tank that extends between a first and second end and includes:
a plurality of elongated rigid tubing portions having a first diameter,
a plurality of connector portions having a second diameter that is smaller than the first diameter and having flexible corrugations and a rigid cuff, and
taper portions disposed between and coupling successive tubing portions and connector portions;
folding the elongated tank to define a folded tank body having a first and second tank body end, with the elongated rigid tubing portions extending in parallel between the first and second tank body ends, and with the plurality of connector portions being disposed at one of the first or second tank body ends;
coupling a first tank mount about connector portions disposed at the first tank body end;
coupling a second tank mount about connector portions disposed at the second tank body end;
hardening the resin on the elongated tank to fix the elongated tank in a folded tank body configuration;
coupling a first interface bracket at the first tank body end and surrounding at least a portion of the connector portions disposed at the first tank body end, the first interface bracket engaging the first tank mount;
coupling a second interface bracket at the second tank body end and surrounding at least a portion of the connector portions disposed at the second tank body end, the second interface bracket engaging the second tank mount; and
coupling the folded tank body within an enclosure via the first and second interface brackets.

2. The method of claim 1, wherein the folded tank body defines a plurality of layers, with each of the plurality of layers being defined at least in part by a plurality of the elongated rigid tubing portions.

3. The method of claim 1, wherein the enclosure comprises:
a plurality of sidewalls, including respectively parallel and opposing lateral sidewalls and end sidewalls;
a base disposed with the sidewalls extending perpendicularly from the base; and
a rim that extends from a top portion of the sidewalls opposing the base.

4. The method of claim 3, further comprising coupling a cover to the enclosure via the rim that extends from a top portion of the sidewalls opposing the base of the enclosure.

5. The method of claim 1, further comprising:
coupling the folded tank body to a rotisserie of an oven via at least one of the first and second tank mounts before the resin is hardened, and
applying heat to the folded tank body in the oven while rotating the folded tank body within the oven to harden the resin.

6. The method of claim 1, further comprising coupling the enclosure assembly to a chassis of a vehicle between wheels of the vehicle, with the enclosure assembly defining a portion of an undercarriage of the vehicle and defining a structural component of the vehicle.

7. An enclosure assembly comprising:
an elongated tank that extends between a first and second end and includes:
a plurality of elongated rigid tubing portions having a first diameter,
a plurality of connector portions having a second diameter that is smaller than the first diameter, and
taper portions disposed between and coupling successive tubing portions and connector portions, wherein
the elongated tank is folded to define a folded tank body having a first and second tank body end, with the elongated rigid tubing portions extending between the first and second tank body ends, and with the plurality of connector portions being disposed at one of the first or second tank body ends;
a first tank mount coupled about connector portions disposed at the first tank body end;
a second tank mount coupled about connector portions disposed at the second tank body end; and
an enclosure, the folded tank body and tank mounts being disposed and secured within the enclosure.

8. The enclosure assembly of claim 7, further comprising:
a first interface bracket disposed at the first tank body end and surrounding at least a portion of the connector portions disposed at the first tank body end, the first interface bracket engaging the first tank mount; and
a second interface bracket at the second tank body end and surrounding at least a portion of the connector portions disposed at the second tank body end, the second interface bracket engaging the second tank mount.

9. The enclosure assembly of claim 7, wherein the folded tank body defines a plurality of layers, with each of the plurality of layers being defined at least in part by a plurality of the elongated rigid tubing portions.

10. The enclosure assembly of claim 7, wherein the enclosure comprises:
a plurality of sidewalls, including respectively parallel and opposing lateral sidewalls and end sidewalls;
a base disposed with the sidewalls extending perpendicularly from the base; and
a rim that extends from a top portion of the sidewalls opposing the base.

11. The enclosure assembly of claim 10, further comprising a cover coupled to the enclosure via the rim that extends from a top portion of the sidewalls opposing the base of the enclosure.

12. The enclosure assembly of claim 7, wherein the enclosure assembly is coupled to a chassis of a vehicle between wheels of the vehicle, with the enclosure assembly defining a portion of an undercarriage of the vehicle.

13. The enclosure assembly of claim 7, wherein each of the first and second tank mounts comprise a plurality of separate tank mount units that couple together to define a plurality of tank mount coupling holes, though which respective sections of one or more connector portions extend and are coupled.

14. The enclosure assembly of claim 13, wherein each of the first and second tank mounts comprise three or more separate tank mount units.

15. A folded tank assembly comprising:
an elongated tank that extends between a first and second end and includes:
a plurality of elongated rigid tubing portions having a first diameter,
a plurality of connector portions having a second diameter that is smaller than the first diameter, and
taper portions disposed between and coupling successive tubing portions and connector portions,
wherein the elongated tank is folded to define a folded tank body having a first and second tank body end, with the elongated rigid tubing portions extending between the first and second tank body ends, and with the plurality of connector portions being disposed at one of the first or second tank body ends;
a first tank mount disposed at the first tank body end; and
a second tank mount disposed at the second tank body end.

16. The folded tank assembly of claim 15, wherein:
the first and second end of the elongated tank are both disposed at the first tank body end and coupled within the first tank mount; or
the first end of the elongated tank is disposed at the first tank body end and coupled within the first tank mount, and the second end of the elongated tank is disposed at the second tank body end and coupled within the second tank mount.

17. The folded tank assembly of claim 15, wherein the folded tank body defines a plurality of layers, with each of the plurality of layers being defined at least in part by a plurality of the elongated rigid tubing portions.

18. The folded tank assembly of claim 15, wherein the folded tank assembly is coupled to a chassis of a vehicle between wheels of the vehicle.

19. The folded tank assembly of claim 15, wherein each of the first and second tank mounts comprise a plurality of separate tank mount units that couple together to define a plurality of tank mount coupling holes, though which respective sections of one or more connector portions extend and are coupled.
